(19) United States
(12) Patent Application Publication
(10) Pub. No.: US 2017/0155526 A1
(43) Pub. Date: Jun. 1, 2017

(54) SMART SOCKET AND SMART SOCKET CONTROL SYSTEM

(71) Applicants: NANNING FUGUI PRECISION INDUSTRIAL CO., LTD., Nanning (CN); HON HAI PRECISION INDUSTRY CO., LTD., New Taipei (TW)

(72) Inventor: JIN-FENG LI, Shenzhen (CN)

(21) Appl. No.: 15/168,893

(22) Filed: May 31, 2016

(30) Foreign Application Priority Data
Nov. 26, 2015 (CN) 201520962545.0

(51) Int. Cl. H04L 12/50; H01R 13/70; H01R 13/717; H01R 13/66

(52) U.S. Cl. CPC H04L 12/50; H01R 13/6675; H01R 13/70; H01R 13/7175; H01R 13/6683

(57) ABSTRACT

A smart socket remotely controllable as to power outputs includes a switch control circuit, a wireless transmission module, and a power module. The switch control circuit is electrically connected to the live line input port and the live line output port, configured to control the connection of the live line. The wireless transmission module is electrically connected to the switch control circuit, to control the switch control circuit in accordance with the receiving wireless signals. The power module can transform AC power to DC power and supply power. A control system is also provided. The smart socket and smart socket control system can provide statistics and analysis of home appliances and respective power consumptions, and also can timely secure and protect electrical appliances, and eliminate fire risks.

### FIELD

The subject matter herein generally belongs to electronic controls, especially relates to smart sockets and control systems.

### BACKGROUND

Various electrical appliances obtain the electrical power for working by means of connecting the plugs to a socket. However, most of the sockets only provide one type of plug, which results in single function and unsophisticated management of electrical appliances. For example, the users forget to switch off some electrical appliance when they are not at home, and the user is not able to use remote controls. The electrical appliances work whether attended or unattended, causing a waste of resources, and fire risk.

### SUMMARY

The present disclosure provides a smart socket, and comprises a switch control circuit, a wireless transmission module, and a power module. The switch control circuit is electrically connected to the live line input port and the live line output port, to control the electrical connection. The wireless transmission module is electrically connected to the switch control circuit, to control the working of the switch control circuit in accordance with signals. The power module is configured to transform alternating current power to direct current power and supply power to aforesaid modules.

The present disclosure also provides a control system, and comprises the aforesaid smart socket, a cloud server, and a wireless terminal. The cloud server wirelessly transmits the smart socket data, and can gather statistics and perform analysis for the data transmitted from the smart socket. The wireless terminal transmits and receives data with the cloud server through the aforesaid wireless connection to obtain the statistical and analyzed data. The wireless terminal also sends wireless signal to the wireless transmission module of the smart socket though the cloud server, to control the switch control circuit.

The smart socket and control system provided by the present disclosure provides convenience, security, and greater levels of control.

### BRIEF DESCRIPTION OF THE DRAWINGS

Implementations of the present technology will now be described, by way of example only, with reference to the attached figures, wherein:

FIG. 1 is a schematic diagram of a control system in a user environment according to an embodiment of the disclosure.

FIG. 2 is a schematic diagram of a smart socket in an embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

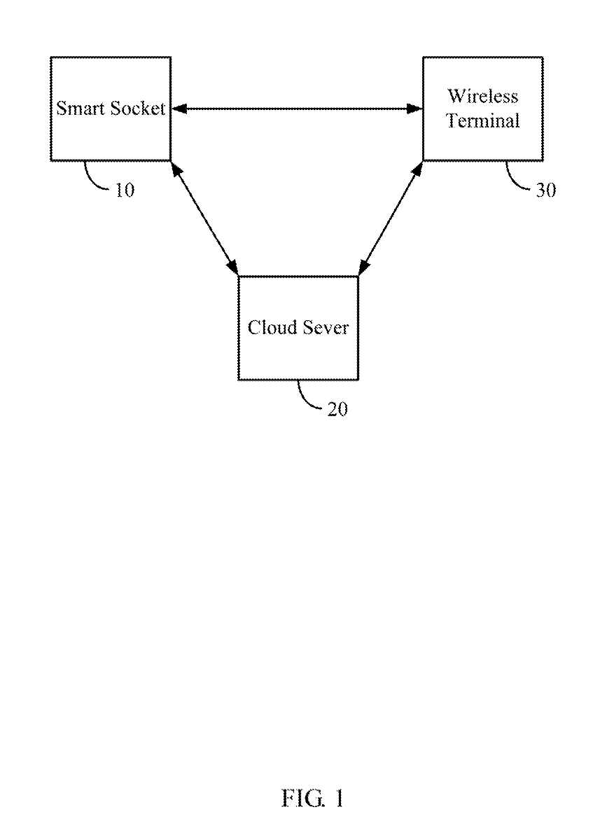

FIG. 1 shows a control system according to an embodiment of the disclosure.

In the present implementation, the control system comprises a smart socket 10, a cloud server 20, and a wireless terminal 30.

The smart socket 10 is electrically connected to an alternating current (AC) power supply and to electrical appliances, to control the electricity which is fed to the electrical appliances. When the electrical appliances obtain electrical power, the smart socket 10 can monitor the power consumption of the electrical appliances, then the smart socket 10 sends data as to the power consumption to the cloud server 20 through the wireless connection.

In the present implementation, the smart socket 10 comprises an live line output port and an ground line output port, the live line is the first line and the ground line is the second line. The live line and ground line are electrically connected to the live line input port and the ground line input port of the smart socket 10. The smart socket 10 outputs AC power to a load 40 through the live line output port and the ground line output port, and the load 40 is each of the electrical appliances plugged into the smart socket 10.

The wireless connection is a home gateway device, such as a router or relay terminal communicating with the internet. In other implementations, the wireless connection can also be realized by other wireless connections, for example, GSM (Global System for Mobile Communications), CDMA (Code Division Multiple Access), BLUETOOTH, ZIGBEE, and others.

When the cloud server 20 receives the data of the power consumption, the cloud server 20 can calculate statistics and analyze the data. For example, the cloud server 20 will makes statistics for the currents and voltages of normal working conditions, to recognize periods within the day or other interval of greater power consumption, and which periods of time consume less power, then sends a wireless signal to stop the smart socket 10 when the electrical appliances act abnormally, and sound or issue an alarm.

The wireless terminal 30 can be directly connected to the smart socket 10 through the wireless connection. When the wireless terminal 30 is directly connected to the smart socket 10, the wireless terminal 30 communicates wirelessly with the smart socket 10 through the wireless terminal 30, and the wireless terminal 30 controls the switch control circuit 103 inside the smart socket 10 is thus controlled by the wireless connection.

In the present implementation, the wireless terminal 30 can communicate with the smart socket 10 through the cloud server 20 by the wireless connection. When the wireless terminal 30 is connected to the cloud server 20 to transmit data, the wireless terminal 30 can obtain statistical data and data for analysis from the cloud server 20. In addition, the wireless terminal 30 also sends the wireless signal to the wireless transmission module 102 of the smart socket 10 through the cloud server 20, to control the working of the switch control circuit 103.

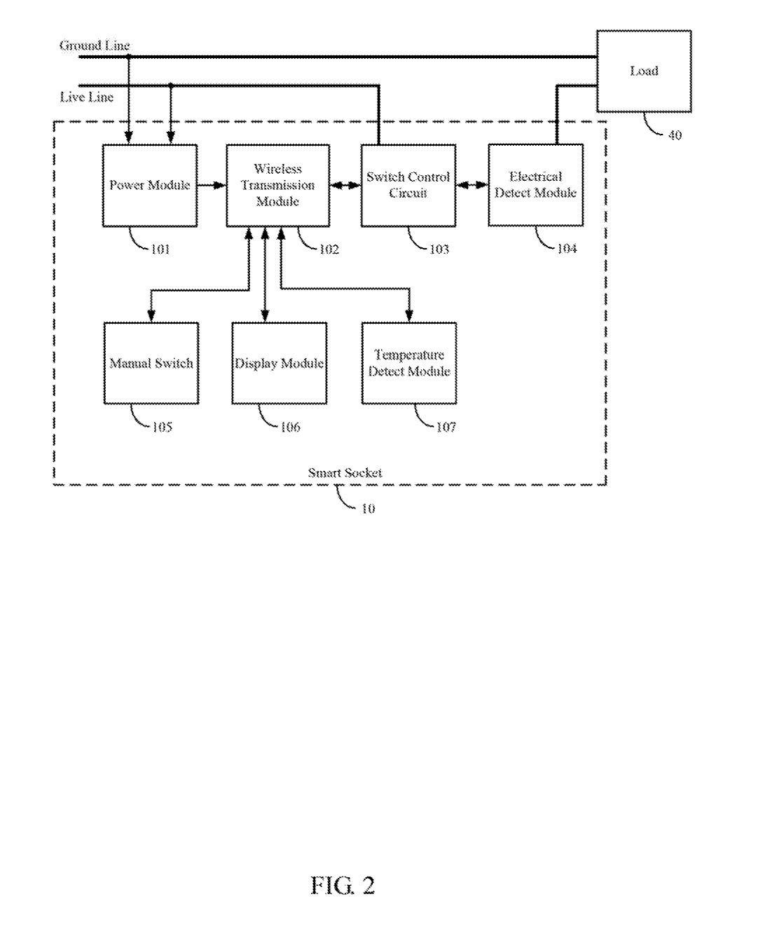

FIG. 2 shows a diagram of a smart socket according to an embodiment of the disclosure.

In the present implementation, the smart socket 10 comprises a switch control circuit 103, a wireless transmission module 102, and a power module 101.

The switch control circuit 103 is electrically connected to the live line input port and the live line output port of the smart socket 10, the switch control circuit 103 is configured to control the switching of the live line. The switching by the switch control circuit 103 can be realized by a relay. The weak current control end of the relay is electrically connected to the wireless transmission module 102, the strong current end of the relay is electrically connected to the live line, the relay can control the connection of the live line after receiving the control signal. In the present implementation, the control signal is the part of the wireless signal sent by the cloud server 20 or the wireless terminal 30 (such as an encoded and modulated wireless control instruction signal).

The wireless transmission module 102 is electrically connected to the switch control circuit 103, to control the switch control circuit 103 according to the received control signal. Remote control by users is thus realized.

The power module 101 can transform the AC power to direct current (DC) power, and supply the power to the relevant modules of the smart socket 10. In the present implementation, the power module 101 mainly transforms 220 volts (V) AC to 3.3 V DC.

In the present implementation, the smart socket 10 can also comprise an electrical detecting module (electrical detect module 104). The electrical detect module 104 is electrically connected to the switch control circuit 103 and the live line output port, to detect instantaneous current, voltage, and working time of the electrical appliances. The electrical detect module 104 is electrically connected to the wireless transmission module 102, and sends the instantaneous current, voltage and working time of the electrical appliances to other devices through the wireless transmission module 102.

The smart socket can also comprise a manual switch 105. In the present implementation, the manual switch 105 is electrically connected to the wireless transmission module 102 and the ground line, to control the wireless transmission module 102. When the manual switch 105 is turned on, the enable terminal of wireless transmission module 102 is electrically connected to the ground line, and the wireless transmission module 102 is disabled. When the manual switch 105 is turned off, the enable terminal of the wireless transmission module 102 is disconnected from the ground line, in other words, the enable terminal of the wireless transmission module 102 is isolated with the ground line, and the wireless transmission module 102 is enabled. In other implementations, the manual switch 105 can be used instead of a transistor (such as a field-effect transistor (FET)), for example, the switch function can be realized by using the base of the FET controlling conduction between the collector and emitter.

The smart socket 10 further comprises a display module 106. The display module 106 is electrically connected to the wireless transmission module 102, to indicate the current working status of the smart socket 10 according to the display signal of the wireless transmission module 102. In the present implementation, the display module 106 can be realized by using at least one LED, such as the LED being on or off to indicate the current working state of the smart socket 10 according to the display signal of the wireless transmission module 102.

The smart socket 10 can also comprise a temperature detection module 107. The temperature detection module 107 is mainly configured to detect the temperature of the smart socket 10. When higher power electrical appliances are used, the power consumption greatly increases, and the internal temperature of the smart socket 10 will increase too. Electrical safety can be assured by detecting the temperature.

The temperature detection module 107 is electrically connected to the wireless transmission module 102, and the temperature detected by the temperature detection module 107 is sent to the other devices through the wireless transmission module 102, such as the cloud server 20 or the wireless terminal. When the temperature is abnormal, the cloud server 20 or the wireless terminal 30 can effectively control the smart socket 10 to avoid any risk of fire or overheating.

In the present implementation, the temperature detection module 107 can detect temperature using a thermistor. When the temperature is high, the resistance of the thermistor changes, so the temperature can be detected by measuring the resistance of the thermistor.

An embodiment of a mobile phone as a load 40 in addition to acting as the wireless terminal 30 will be illustrated.

When the mobile phone is electrically connected to the smart socket 10 through the charger, the smart socket 10 will be awakened. Then the smart socket 10 communicates with the mobile phone by wireless connection to query the model of the mobile phone. The smart socket 10 can communicate with the cloud server 20 through the wireless connection to obtain parameters (such as the battery capacity and so on), and the smart socket 10 will charge the mobile phone after information as to the mobile phone is received.

The smart socket 10 detects the instantaneous current, voltage, and the working time of the electrical appliances through the electrical detect module 104 and sends the data to the cloud server 20 to make statistics of the charging status (such as the charged and chargeable capacity, and so on). The cloud server 20 controls the smart socket according to the charging status of the mobile phone, for example, the power output of the smart socket 10 would be closed when the mobile phone is fully charged, the cloud server 20 sends message to mobile phone according to the charging status of the mobile phone, such as warning if the mobile phone is abnormal when the charging status is abnormal.

An embodiment of a refrigerator acting as the load 40 will be illustrated.

The smart socket 10 is woken when the plug of the refrigerator (as another example of a load 40) is electrically connected to the smart socket 10. Then, the smart socket 10 detects the instantaneous current, voltage, and working time. It is well known that the refrigerator is working in different periods, and alternatively works at the thermal insulation state and the refrigeration state, and the power of thermal insulation state is different from the power of refrigerating state, so after the refrigerator working for a period of time, the smart socket 10 will detect instantaneous currents and voltages and transmit to the cloud server 20 to make statistics. The cloud server 20 makes statistics for the currents and voltages at different periods of time, and compares the statistical data to preset data or database information of big data to determine normal and abnormal working states.

When the refrigerator works normally, the cloud server 20 continues to make statistics for the cumulative working time according to the data of currents and voltages to remind the user to do maintenance at times.

When the refrigerator works abnormally, the cloud server 20 would warn the user through the wireless terminal 30 in time, and can also turn off the output of AC by the smart socket 10 if necessary.

The foregoing description, for purposes of explanation, has been described with reference to specific embodiments. However, the illustrative discussion above are not intended to be exhaustive or to limit the disclosure to the precise forms disclosed. Many modifications and variations are possible in view of the above teachings. The various modifications from the principles of the disclosure will therefore be included and protected within the scope of the claims.

What is claimed is:

1. A smart socket device, comprising:
a switch control circuit coupled to a first line input port and a first line output port, configured to control connections of the first line;
a wireless transmission module coupled to the switch control circuit, which is configured to control the switch control circuit according to a wireless signal; and
a power module is configured to transform an alternating current power to a direct current power, and supply the direct current power to the switch control circuit and the wireless transmission module.

2. The smart socket device of claim 1, further comprising an electrical detect module; and the electrical detect module is coupled to the switch control circuit and the output port of the first line; and the electrical detect module is configured to detect an instantaneous current, voltage, and working time of electrical appliances.

3. The smart socket device of claim 2, wherein the electrical detect module is coupled to the wireless transmission module; and the electrical detect module is configured to send the instantaneous current, voltage, and working time of the electrical appliances to other devices through the wireless transmission module.

4. The smart socket device of claim 1, further comprising a manual switch; and the manual switch, coupled to the wireless transmission module and a second line, is configured to enable or disable the wireless transmission module.

5. The smart socket device of claim 4, wherein the manual switch is configured to turn on to make a enable terminal of the wireless transmission module coupled to the second line, to disable the wireless transmission module; and the manual switch is configured to turn off to make the enable terminal of the wireless transmission module isolated with the second line, to enable the wireless transmission module.

6. The smart socket device of claim 1, further comprising a display module, the display module is coupled to the wireless transmission module, and the display module is configured to indicate current work status of the smart socket device according to display signal of the wireless transmission module.

7. The smart socket device of claim 6, wherein the display module comprises at least one LED.

8. The smart socket device of claim 1, further comprising a temperature detection module; and the temperature detection module, coupled to the wireless transmission module, is configured to send a temperature detected by the temperature detection module to other devices through the wireless transmission module.

9. The smart socket device of claim 8, wherein the temperature detection module comprises a thermistor to detect the temperature.

10. A control system, comprising:
the smart socket device of claim 1;
a cloud server, which is configured to communicate with the smart socket device through wireless connection, and make statistics and analysis for data transmitted from the smart socket device;
a wireless terminal, which is configured to communicate with the cloud server through the wireless connection, to obtain statistical and analyzed data; and
wherein the wireless terminal sends the wireless signal to the smart socket device through the cloud server to control the switch control circuit work.
